(19) United States
(12) Patent Application Publication
(10) Pub. No.: US 2014/0006272 A1
(43) Pub. Date: Jan. 2, 2014

(54) NOTIFYING MOBILE DEVICE USERS OF A SUGGESTED PAYMENT TYPE PRIOR TO CONDUCTING A TRANSACTION AT A MERCHANT

(71) Applicants: Matthew A. Calman, Charlotte, NC (US); David M. Grigg, Rock Hill, SC (US); Susan Smith Thomas, Gastonia, NC (US); Alicia C. Jones, Fort Mill, SC (US)

(72) Inventors: Matthew A. Calman, Charlotte, NC (US); David M. Grigg, Rock Hill, SC (US); Susan Smith Thomas, Gastonia, NC (US); Alicia C. Jones, Fort Mill, SC (US)

(73) Assignee: Bank of America Corporation, Charlotte, NC (US)

(21) Appl. No.: 13/536,795

(22) Filed: Jun. 28, 2012

(51) Int. Cl. G06Q 40/00

(52) U.S. Cl. 705/40

(57) ABSTRACT

Devices, methods and computer program are defined that provide for notifying (e.g., alerting) users of mobile devices as to suggested payment types accepted by the merchant at which the user is located. The suggested payment type may be one that is favorable or beneficial to the user in terms of discounts/rebates, transaction fee reduction, rewards points transaction processing security and/or extended warranty coverage for items transacted and/or the like. As a result the user makes informed decisions on which payment type to use for an impending transaction at the merchant.

### FIELD

In general, embodiments herein disclosed relate to commerce and, more specifically, notifying mobile device users of a best payment method type prior to conducting a transaction at a merchant.

### BACKGROUND

Mobile payment, also referred to as mobile money, mobile banking or mobile wallet, allows for the user/customer to conduct a transaction (i.e., pay for goods or services) using their mobile communication device as the payment vehicle as opposed to conventional means for payment (e.g., cash, credit/debit card, check or the like). Many different types of mobile payment are currently in use or will be in use in the future. For example, short range wireless communication, such as Near Field Communication (NFC), Wi-Fi, Bluetooth® or the like, allows for mobile payment via mobile communication device's equipped with requisite short range wireless communication functionality, such as a NFC chip (or some other close-range wireless protocol chip). The NFC or other short range wireless functionality provides for the mobile communication device to wirelessly exchange payment credentials in a secure environment with a corresponding point-of sale (POS) terminal, which is also configured with the requisite short range wireless functionality.

In another example, visual indicia exchange may be implemented between the mobile communication device and the payment terminal. For example, the POS terminal may display computer-readable indicia, such as a barcode, Quick Response (QR) code or the like, which is captured by the mobile communication device via an image capture mechanism (i.e., a camera or the like) embodied with the mobile communication device. In response to receipt and processing of the computer-readable indicia the mobile communication device will communicate payment credentials to the POS. In specific example, the mobile communication device may generate and displays another indicia, which includes the customer's payment credentials and is subsequently captured by the POS terminal.

In a related example, computer-readable indicia may be implemented in conjunction with cloud storage of the customer's credentials. In such an example, the POS terminal may display computer-readable indicia, such as a barcode, Quick Response (QR) code or the like, which is captured by the mobile communication device and provides for the mobile communication device to connect with the cloud. Once the mobile and the POS terminal have connected with the cloud, secure key exchange provides the authentication for the customer's payment credentials to be communicated form the cloud storage to the POS terminal.

The various different mobile payment types all require the mobile communication device and/or the related payment applications to perform functions that are specific to the mobile payment type. For example, Short-range communication, such as NFC requires activation of the short-range/NFC chip for broadcasting such communications, image/code capturing requires activation of the image capturing device (i.e., camera) and the like. In practice, the customer may be unaware of which type(s) of mobile payment type a merchant accepts until they are about to conduct the payment transaction (i.e., at that the POS terminal). An inefficiency is realized in terms of overall transaction time, if the customer is required to manually configure the mobile communication device for mobile payment of the type accepted by the retailer when the customer is about to conduct a transaction (i.e., at the POS terminal). Moreover, if the customer, within a short period of time, is unable to manually configure their mobile communication device at the POS terminal, the customer may forego a mobile payment and resort to conventional payment means (i.e., cash, check, credit/debit or the like).

In other instances in which the merchant accepts multiple different payment types, mobile and otherwise, a user may be unaware, at the time of the conducting at transaction at the merchant, as to which payment type is the most favorable for the user/consumer. For example, a merchant may be currently offering a discount or rebate for using a particular payment type or waiving or lowering a transaction fee associated with the payment type. In another example, the payment type may offer increased security or an ancillary benefit, such as an extended warranty or the like. In this regard, if the user was made aware of the most favorable payment type, proximate in time to making the transaction, the user will be prone to use the most favorable payment type for the transaction.

Therefore, a need exists for making consumers aware of suggested (i.e., most favorable) payment types based on the payment types accepted by the merchant. The suggested payment types should take into account benefits offered by the merchant associated with the payment type and/or benefits offered by the payment type, in general. In addition, the consumer should be made aware of the suggested payment types proximate in time to conducting the transaction so that the suggested payment types are acted upon by the user/consumer.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Mobile communication devices, methods and computer program products are defined that provide for notifying mobile device users of one or more suggested payment types accepted by a merchant at which the user is located. The suggested payment type is one or more that is beneficial or favorable to the user in terms of discounts/rebates, fee reduction/waiving, rewards points, security in transaction processing, warranty coverage for items transacted or the like. The user is notified or alerted via the mobile communication device proximate in time to conducting a transaction with the merchant so that the user can act upon the suggested payment type.

A mobile communication device configured for providing a user with notification of a suggested payment type for conducting a transaction while at a merchant location, defines first embodiments of the invention. The mobile communication device includes a computing platform including a memory and at least one processor in communication with the memory. The mobile communication device additionally includes a suggested payment type notification module stored in the memory and executable by the processor. The suggested payment type notification module is configured to determine a plurality of payment types accepted by a merchant at which the mobile communication device is located and, in response to determination of the payment types, determine one or more of the payment types to suggest to the user as a payment type for a pending transaction. The module is further configured to generate, and communicate to the user via the mobile communication device, a notification that indicates the one or more suggested payment types.

In specific embodiments of the mobile communication device, the suggested payment type notification module is further configured to determine a geographic location of the mobile communication device and identify the merchant based on the geographic location of the mobile communication device. In such embodiments of the mobile communication device, the suggested payment type notification module is further configured to determine the plurality of payment types accepted by the merchant by accessing a payment type database that indicates the plurality of payments types accepted by the merchant.

In other specific embodiments of the mobile communication device, the suggested payment type notification module is further configured to determine the plurality of payment types accepted by the merchant by capturing computer readable-indicia displayed at the merchant, wherein the computer readable-indicia indicates the plurality of payment types accepted by the merchant.

In further specific embodiments of the mobile communication device, the suggested payment type notification module is further configured to determine one or more of the payment types to suggest to the user based on at least one of a discount associated with a payment type, a rebate associated with a payment type, rewards program benefits associated with the payment type, warranty protection associated with a payment type or security in processing a transaction associated with a payment type. In such embodiments of the mobile communication device, the suggested payment type notification module may be further configured to determine the one or more of the payment types to suggest to the user by accessing a database that maps the merchant to discounts or rebates associated with a payment type.

In further related embodiments of the mobile communication device, the suggested payment type notification module is further configured to determine one or more of the payment types to suggest to the user based on at least one of an approximate transaction amount of a pending transaction with the merchant or one or more item types in the pending transaction with the merchant.

Moreover, according to other embodiments of the mobile communication device, the suggested payment type notification module is further configured to determine a mobile payment type to suggest to the user. In such embodiments the mobile communication device may further include a mobile payment activation module stored in the memory and executable by the processor. The mobile payment activation module is configured to automatically activate one or more mobile payment mechanisms associated with the mobile payment type, wherein the mobile payment mechanisms are automatically activated based on selection, within the notification, of the mobile payment type by the user.

A method for notifying mobile communication device users of a suggested payment type for conducting a transaction while at a merchant location provides for second embodiments of the invention. The method includes determining, by a computing device processor, a plurality of payment types accepted by a merchant at which the mobile communication device is located. In addition the method includes determining, by a computing device processor, one or more of the payment types to suggest to the user as a payment type for a pending transaction. Moreover, in addition the method includes generating, and initiating communication to a user interface on the mobile communication device, a notification that indicates the one or more suggested payment types.

In specific embodiments the method further includes determining a geographic location of the mobile communication device and identifying the merchant based on the geographic location of the mobile communication device. In such embodiments of the method, determining the plurality of payment types accepted by the merchant may further include accessing a payment type database that indicates the plurality mobile payments types accepted by the merchant.

In other specific embodiments of the method, determining the plurality of payment types accepted by the merchant further includes capturing computer readable-indicia displayed at the merchant, wherein the computer readable-indicia indicates the plurality of payment types accepted by the merchant.

In additional specific embodiments of the method, determining the one or more payment types to suggest to the user further includes determining the one or more of the payment types to suggest to the user based on at least one of a discount associated with a payment type, a rebate associated with a payment type, warranty protection associated with a payment type or security in processing a transaction associated with a payment type. In such embodiments of the method, determining the one or more payment types to suggest to the user may further include accessing a database that maps the merchant to discounts or rebates associated with a payment type.

In related embodiments the method includes receiving, at the mobile communication device, an input that identifies at least one of an approximate transaction amount or item type for a pending user transaction with the merchant. In such embodiments of the method determining the one or more of the payment types to suggest to the user further includes determining the one or more payment types to suggest to the user based on at least one of the approximate transaction amount or the item type.

Moreover, in specific embodiments of the method, determining the one or more payment types to suggest to the user further includes determining a mobile payment type to suggest to the user. In such embodiments the method may further include automatically activating one or more mobile payment mechanisms associated with the mobile payment type, wherein the mobile payment mechanisms are automatically activated based on selection, within the notification, of the mobile payment type by the user.

A computer program product including a non-transitory computer-readable medium defines third embodiments of the invention. The computer-readable medium includes a first set of codes for causing a mobile communication device to determine a plurality of payment types accepted by a merchant at which the mobile communication device is located. The computer-readable medium additionally includes a second set of codes for causing a mobile communication device to determine one or more of the payment types to suggest to the user as a payment type for a pending transaction. In addition, the computer-readable medium includes a third set of codes for causing a mobile communication device to generate, and communicate to a user interface on the mobile communication device, a notification that indicates the one or more suggested payment types.

Thus, as described in more details below devices, methods and computer program are defined that provide for notifying (e.g., alerting) users of mobile devices as to suggested payment types accepted by the merchant at which the user is located. The suggested payment type may be one that is favorable or beneficial to the user in terms of discounts/rebates, transaction fee reduction, rewards points transaction processing security and/or extended warranty coverage for items transacted and/or the like. As a result the user makes informed decisions on which payment type to use for an impending transaction at the merchant.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic diagram of a system for automatically activating mobile payment mechanisms based on automated identification of the mobile payment types accepted by a merchant, in accordance with one embodiment of the present invention;

FIG. 2 is a block diagram of a mobile communication device configured for automatic activation of mobile payment mechanisms based on automated identification of the mobile payment types accepted by a merchant, in accordance with one embodiment of the present invention;

FIG. 3 is a flow diagram of a method for automatically activating mobile payment mechanisms based on automated identification of the mobile payment types accepted by a merchant, in accordance with an embodiment of the present invention;

FIG. 4 is a block diagram of a mobile communication device configured for providing notifications that indicate a suggested payment type based on payment types accepted by a merchant at which the user is located, in accordance with embodiments of the present invention; and

FIG. 5 is a flow diagram of a method for notifying mobile communication device users of a suggested payment type for conducting a transaction while at a merchant location; in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, and the like and/or may not include all of the devices, components, modules and the like, discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, systems and computer program products are defined that provide for automatic activation of mobile payment mechanisms (e.g., software applications, devices/hardware and the like) on a mobile communication device in response to automated determination of the mobile payment types accepted by a merchant at which the user/consumer is located. In one embodiment location determining mechanisms, such as Global Positioning System (GPS) devices are implemented on the mobile communication device to determine the geographic location of the mobile determine and identify a merchant/retailer associated with the location. Once the merchant has been identified, the mobile communication network communication determines the mobile payment type(s) accepted by the merchant by accessing an internally stored mobile payment type database or a network-based mobile payment type database. In response to determining the mobile payment type(s) accepted by the merchant, the mobile communication device automatically activates the mobile payment mechanisms associated with mobile payment type.

In this regard, the present invention serves to make the user/consumer aware of an option for a conducting a transaction using the mobile payment type(s) accepted by the merchant. In addition, the mobile payment transaction is made more efficient, in that, the user/consumer does not have to manually configure and/or activate the software or hardware associated with the mobile payment type.

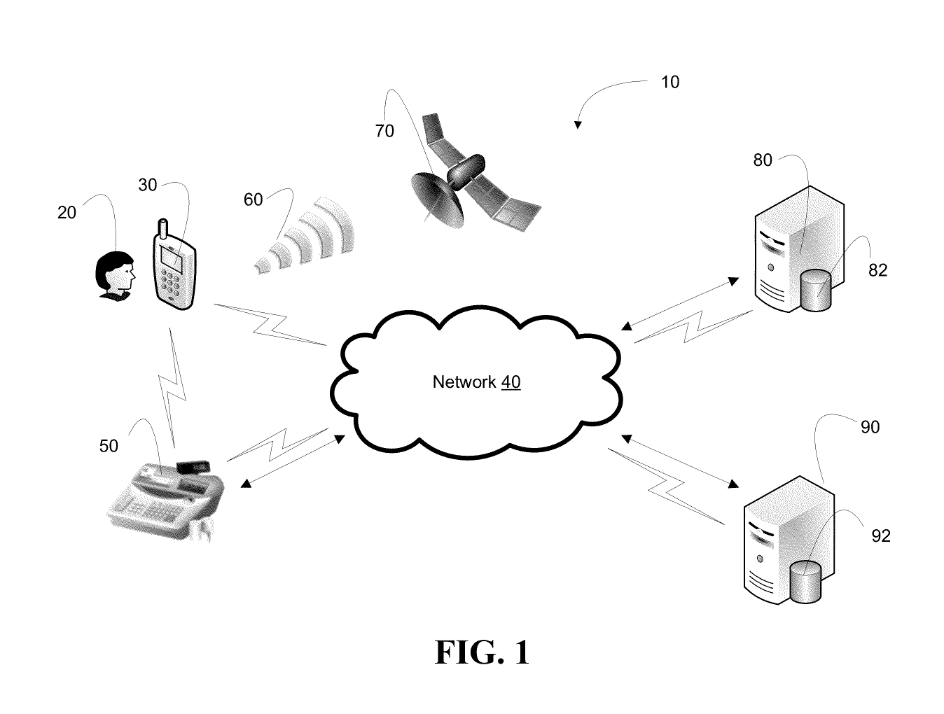

Referring to FIG. 1 a block diagram is provided of a system 10 for automatically activating mobile payment mechanisms in response to automated identification of mobile payment types accepted by a merchant; in accordance with embodiments of the present invention. The system 10 includes a user/consumer 20 in possession of a mobile communication device 30, such as a cellular/wireless telephone or the like configured to provide for wireless communication via network 40. In addition, mobile communication device 30 is configured to provide for conducting mobile payment (otherwise referred to as mobile wallet, mobile money, mobile money transfer and the like) implementing one, and in many instances more than one, mobile payment type (e.g., short-range wireless communication, image/code capture communication or the like). Mobile payment provides for the user's payment credentials (e.g., payment account number, authentication attributes and the like) to be wirelessly communicated from the mobile communication device or an intermediary (e.g., a cloud) to a corresponding Point-Of-Sale (POS) terminal 50 configured to accept mobile payment of the corresponding mobile payment type.

In accordance with embodiments of the invention, the mobile communication device 30 is configured to identify a merchant. In specific embodiments the mobile communication device is configured to automatically identify a merchant at which the user 20, in possession of the mobile communication device 30, is currently located or is proximate in location. In such embodiments, the mobile communication device includes a location-determining device, such as a Global Positioning System (GPS) device or the like, which provides for broadcasting signals 60 to a plurality of location-determining satellites 70 to determine the current location of the mobile communication device 30. The mobile communication device 30 is additionally in communication, via network 40, with a network device 80 that includes a mapping database 82 configured to identify the merchant located at or proximate to the current location of the mobile communication device 30.

In other embodiments of the invention, the merchant may be identified by user 20 input (via a mobile payment user-interface or the like) or the merchant may be identified by receipt of wireless communication or capture of images/codes which identify the merchant.

Once the merchant has been identified, the mobile communication device 30 determines one or more mobile payment types accepted by the merchant. Such a determination may be conducted by communicating, via network 40, with a network device 90 that stores a comprehensive mobile payment type database 92 that maps merchants to the mobile payment type(s) accepted by the merchant. The comprehensive database may be dynamically updated to reflect the current mobile payment types accepted by merchants. Such dynamic update may be accomplished via crowd sourcing (i.e., user/consumer inputs based on experience with a merchant), actual user/consumer transaction data, known merchant information provided by merchants or the like.

In other embodiments the determination of the mobile payment types accepted by a merchant may be conducted by accessing an internal mobile payment database (not shown in FIG. 1) stored locally on the mobile communication device. The internal mobile payment database may store mobile payment types for all merchants that the user 20 has previously conducted a mobile payment transaction. In one specific embodiment of the invention, determination of the mobile payment types accepted by a merchant may provide for accessing the internal mobile payment database and, if the internal database does not include currently include information pertaining to the merchant of interest, subsequently communicating with the network-based comprehensive mobile payment type database.

In response to determining one or more mobile payment types accepted by the merchant, the mobile communication device 30 automatically activates one or more mobile payment mechanisms, if the mobile communication device supports (includes the requisite hardware and/or software) at least one of the one or more mobile payment type(s) accepted by the merchant. In the event that the merchant only accepts one type of mobile payment, the mobile communication activates one or more mobile payment mechanisms (e.g., related hardware, software, firmware or the like) associated with the mobile payment type. For example, if the mobile payment type accepted by the merchant is of a short-range wireless communication type, such as NFC or like, activation of the mobile payment mechanisms includes activation of the short-range wireless device (e.g., an NFC chip) to allow for broadcasting the short-range wireless signals necessary for communicating payment credentials from the mobile communication device 20 to the POS terminal 50. In another example, if the mobile payment type accepted by the merchant is of an image capture type, such as QR code, barcode or the like, activation of the image capturing device (e.g., camera) and a related software application that displays a prompt directing the user 20 to capture the requisite image/code.

In those embodiments in which the merchant accepts two or more mobile payment types and the mobile communication device supports at least two of the mobile payment types, the mobile payment mechanisms activated may be predetermined by user configuration or merchant configuration, such that, the user 20 may prefer one mobile payment type versus other mobile payment types or the merchant may prefer that the user 20 use a preferred mobile payment type. In alternate embodiments, a user prompt may be displayed directing the user 20 to select from the two or more mobile payment types accepted by the merchant and, upon selection of a mobile payment type, automatic activation of the related mobile payment mechanisms occurs. Alternatively, a user prompt may be displayed directing the user to confirm the previously configured user preference or to override the previous preferred user preference and select from the two or more mobile payment types accepted by the merchant.

In the event that the merchant is determined to not accept any mobile payment or not accept a mobile payment type implemented by the mobile communication device, in lieu of activating mobile payment mechanisms, an alert, such as a prompt, audible signal or the like, may be communicated to the user via the mobile communication device, notifying the user that some other form of payment (cash, check, credit/debit card or the like) will need to be used to conduct a transaction with the merchant.

In most embodiments, automatic activation of the mobile payment mechanisms associated with a mobile payment type accepted by the merchant will not coincide with initiation of the mobile payment process. This is because in most embodiments, the user 20 will be required to take some other overt action, such as authorize payment, capture an image/code or the like to initiate or consummate the payment transactions. However, in other embodiments of the invention automatic activation of the mobile payment mechanisms may indeed initiate the mobile payment process.

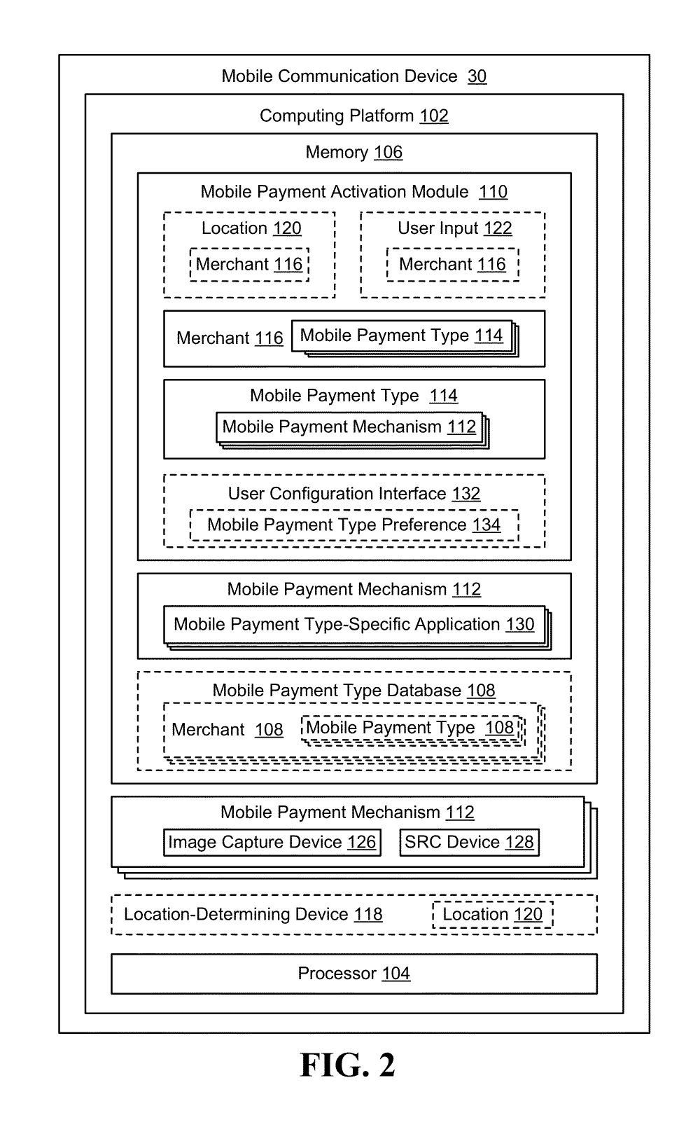

Referring to FIG. 2, a block diagram is depicted of an mobile communication device 30 configured for automatic activation of one or more mobile payment mechanisms in response to a determination of one or more mobile payment types accepted by a merchant, in accordance with embodiments of the present invention. The mobile communication device 30 includes a computing platform 102 having one or more processors 104 and a memory 106 in communication with the processor(s) 104. The memory 106 may comprise volatile and non-volatile memory, such as read-only and/or random-access memory (RAM and ROM), EPROM, EEPROM, flash cards, or any memory common to computer platforms. Further, memory 106 may include one or more flash memory cells, or may be any secondary or tertiary storage device, such as magnetic media, optical media, tape, or soft or hard disk.

Further, computing platform 102 also includes processor 104, which may be an application-specific integrated circuit (“ASIC”), or other chipset, processor, logic circuit, or other data processing device. Processor 104 or another processor such as ASIC may execute an application programming interface (“API”) (not shown in FIG. 2) that interfaces with any resident programs, such as mobile payment activation module 110 or the like stored in the memory 106 of the apparatus 100.

Processor 104 may include various processing subsystems (not shown in FIG. 2) embodied in hardware, firmware, software, and combinations thereof that enable the functionality of mobile communication device 30 and the operability of the device 30 on wireless network. For example, processing subsystems allow for initiating and maintaining communications and exchanging data with other devices in the network. For the disclosed aspects, processing subsystems of processor 104 may include any subsystem used in conjunction with mobile payment activation module 110 or subcomponents or sub-modules thereof

The memory 106 of mobile communication device 30 includes mobile payment activation module 110 configured to automatically activate one or more mobile payment mechanisms 112 (e.g., software, hardware, firmware or the like) in response to identification of the mobile payment type(s) 114 accepted by a merchant 116, in accordance with embodiments of the present invention.

In addition, the mobile payment activation module 110 may be configured to identify a merchant 116 at which the user, in possession of the mobile communication device 30, is currently located or is proximate in location. In such embodiments, the mobile communication device 30 includes a location-determining device 118, such as a Global Positioning System (GPS) which provides for broadcasting signals to a plurality of location-determining satellites to determine the current location 120 of the mobile communication device 30. Once the current location 120 has been determined, the mobile payment activation module 110 or some other routine/module/application executable on the mobile communication device may identify the merchant 116 associated with the location. For example, the mobile communication device 30 may access a network-based mapping database (not shown in FIG. 2), which maps the geographic location to a merchant. In other embodiments of the invention the merchant 116 may be identified by other automated or non-automated means. For example, the mobile communication device 30 may be configured to receive wireless communication from the merchant that is configured to identify the merchant 116 or the user of the mobile communication device may capture images/codes at the merchant 116 that identifies the merchant 116. Additionally, the merchant 116 may be identified by user input 122 to a merchant-identifying user interface.

The mobile payment activation module 108 is further configured to identify the mobile payment type or types accepted by the merchant. In specific embodiments, the mobile payment activation module accesses a network-based mobile payment type database (not shown in FIG. 2) to determine the mobile payment type(s) accepted by the identified merchant. As previously noted the network-based mobile payment type database is a comprehensive database that may be configured for dynamic update to reflect the current mobile payment types accepted by merchants. Such dynamic update may be accomplished via crowd sourcing, actual user/consumer transaction data, known merchant information provided by merchants or the like.

In other specific embodiments, the memory 106 of mobile communication device includes mobile payment database 124 that stores information regarding the mobile payment type 114 accepted by various merchants 116. The mobile payment database 124 may be configured to automatically capture mobile payment type 114 information based on mobile payment transactions conducted by the user. In addition, the mobile payment database 124 may be configured to receive user inputs that indicate the mobile payment type(s) 114 accepted by a merchant 116 (regardless of whether the user has conducted a mobile payment with the merchant). In further specific embodiments of the module, determination of the mobile payment type(s) accepted by a merchant may provide for accessing the mobile payment database 124 to make a determination as whether the database 124 includes mobile payment type 114 information for the merchant 116 of interest and, if the database 124 does not include information pertaining to the merchant 116 of interest, subsequently communicating with the network-based comprehensive mobile payment type database to determine the mobile payment type(s) 114 accepted by the merchant 116 of interest.

The mobile payment activation module 108 is further configured to automatically activate one or more mobile payment mechanisms 112 associated with one of the mobile payment types 114 accepted by the identified merchant 116. The mobile payment mechanisms 112 may include hardware, such as image capture device 126, short-range communication device 128 or the like. Additionally, the mobile payment mechanisms 112 may include software (e.g., module, routines, applications, tools or the like), such as mobile-payment type-specific applications 130 each associated with a specific mobile payment type. For example, an image/code capture mobile payment application, a short-range wireless/NFC mobile payment application and the like. It should be noted that the mobile payment mechanisms shown and described are merely examples and, as such, the inventive concepts herein disclosed provide for automatically activating any known or future known mobile payment mechanisms as they pertain to a known or future-known mobile payment type.

The mobile payment activation module 110 may, in some embodiments, additionally include user configuration interface 132 configured to provide for the user to configure automatic activation of mobile payment mechanisms. In specific embodiments, the user configuration interface 132 is configured to allow the user to define mobile payment type preference(s) 134. Mobile payment type preferences 134 may provide for the user to define a preferred mobile payment type to be activated in the event the merchant accepts more than one mobile payment type. In other embodiments the module 110 may be configured to display a prompt (not shown in FIG. 2) on the mobile communication device prior to automatically activating the mobile payment mechanisms. The prompt may be configured to provide for the user to select from amongst two or more mobile payment types accepted by the merchant or to confirm or override the mobile payment type preference 134 previously configured by the user.

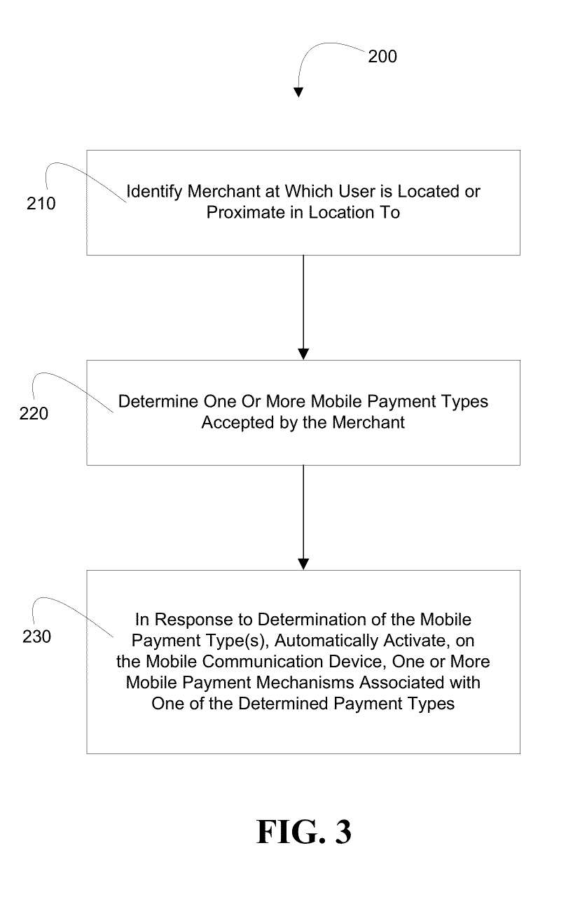

FIG. 3 is a high-level flow diagram of a method 200 for automatically activating mobile payment mechanisms in response to determination of the mobile payment type(s) accepted by a merchant. In accordance with embodiments of the present invention. At Event 210, a merchant is identified at which a user, in possession of a mobile communication device, is currently located or is close to in proximity. In such embodiments the mobile communication device may implement location-determining mechanisms to determine a geographic location of the device and access a database to identify a merchant located at the geographic location. In other embodiments of the invention, the merchant may be identified by user input.

At Event 220, one or more mobile payment types accepted by the identified merchant are determined. In certain embodiments, the determination of mobile payment type(s) accepted by the merchant is conducted by accessing a network-based mobile payment type database that is configured to map merchants to their known accepted merchant payment types. In other embodiments, the determination of mobile payment type(s) accepted by the merchant is conducted by accessing a locally-stored merchant payment type database on the mobile communication device. The locally-stored merchant payment type database may be configured to automatically store mobile payment type(s) accepted by a merchant based on a user conducting a mobile payment transaction with the merchant. In other embodiment, the determination of mobile payment type(s) accepted by the merchant may look first to the locally-stored merchant payment type database and, if the merchant payment type of the merchant of interest is not found in the locally-stored database, access the network-based merchant payment type database.

At Event 230, in response to determination of the mobile payment type(s) accepted by a merchant, one or more mobile payment mechanisms are automatically activated on the mobile communication device. For example, related mobile payment type-specific software/modules may automatically be launched and/or hardware may be activated. Such as image capture device, short-range-wireless device and the like. In the event that the merchant has been determined to accept more than one mobile payment type and the mobile communication device is configured to implement two or more of the mobile payment types accepted by the merchant, the user or the merchant may have predefined a preferred mobile payment type. In other embodiments of the method, a prompt may be displayed to the user prior to automatic activation of the mobile payment mechanisms, requiring the user select one of the mobile payment types accepted by the merchant, confirm a preference, or override a preference with a current selection of a mobile communication type.

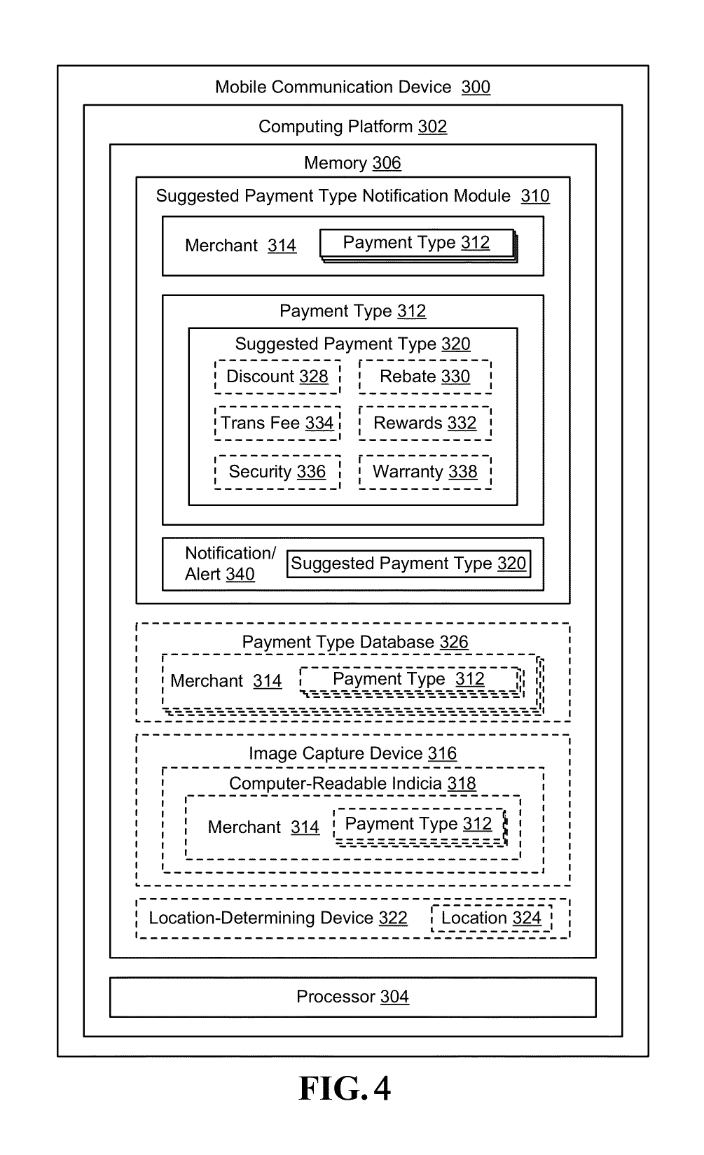

Referring to FIG. 4, a block diagram is depicted of a mobile communication device 300 configured for notifying customers of a suggested payment type(s) accepted by a merchant while the customer is located at the merchant accepted by the merchant, in accordance with embodiments of the present invention. The suggested payment type may, in certain embodiments, be the payment type that is most favorable for the customer. The most favorable payment type may be based on one more attributes, such as, but not limited to, discounts afforded by the payment type, rebates/cash-back incentives afforded by the payment type, transaction fee offset or waiver associated with a payment type, rewards program benefit associated with a payment type, transaction security features afforded by the payment type, extended warranty coverage afforded by the payment type or the like. The mobile communication device 300 may comprise a mobile telephone (i.e., a smartphone or the like) in possession of a customer. The mobile communication device 300 includes a computing platform 302 having one or more processors 304 and a memory 106 in communication with the processor(s) 304. The memory 306 may comprise volatile and non-volatile memory, such as read-only and/or random-access memory (RAM and ROM), EPROM, EEPROM, flash cards, or any memory common to computer platforms. Further, memory 306 may include one or more flash memory cells, or may be any secondary or tertiary storage device, such as magnetic media, optical media, tape, or soft or hard disk.

Further, computing platform 302 also includes processor 304, which may be an application-specific integrated circuit (“ASIC”), or other chipset, processor, logic circuit, or other data processing device. Processor 304 or another processor such as ASIC may execute an application programming interface (“API”) (not shown in FIG. 4) that interfaces with any resident programs, such as suggested payment type notification module 310 or the like stored in the memory 306 of the mobile communication device 300.

Processor 304 may include various processing subsystems (not shown in FIG. 4) embodied in hardware, firmware, software, and combinations thereof that enable the functionality of apparatus 300 and the operability of the mobile communication device 300 on a wireless network. For example, processing subsystems allow for initiating and maintaining communications and exchanging data with other devices in the network. For the disclosed aspects, processing subsystems of processor 304 may include any subsystem used in conjunction with suggested payment type notification module 310 or subcomponents or sub-modules thereof

The memory 306 of apparatus 300 includes payment type notification module 310 that is configured to notify a customer 312 of at least one suggested payment type accepted by a merchant prior to the customer conducting a transaction at the merchant. Such notification serves to bring to the customer's attention one or more suggested payment types, the suggested payment type may one that is most favorable to the customer in terms of one or a combination of discounts, rebates, transaction fee waivers, rewards program benefits, transaction security features, warranty extension or the like. In addition, such notification serves to make the customer aware of payment types that they may have been otherwise unaware of their acceptance by the merchant. Such lack of knowledge of merchant acceptance may be especially prevalent amongst customers if the payment type is a new/emerging payment type, such as the mobile payment types discussed above.

The suggested payment type notification module 310 is configured to determine payment types 312 accepted by a merchant 314 at which the mobile communication device 300 is located. In specific embodiments of the invention, such determination of payment types 312 accepted by the merchant 314 may involve capturing computer readable-indicia (e.g., a QR code or the like) displayed at the merchant, such as a check-in code displayed proximate a point of entry or a code displayed proximate a point of sale (POS) terminal. In such embodiments, mobile communication device 300 includes image capture device 316, such as a camera or the like, configured to capture the computer readable-indicia 318 which, when read by a related application (not shown in FIG. 4) executed on the mobile communication device, identifies the merchant 314, as well as the payment types 312 accepted by the merchant and, in some instances, the suggested payment type 320.

In other specific embodiments of the invention, determination of payment types 312 accepted by the merchant may be fully automated procedure. In such embodiments, the suggested payment type notification module 310 may be configured to identify the merchant 314 at which the user, in possession of the mobile communication device 30, is currently located or is proximate in location. In such embodiments, the mobile communication device 300 includes a location-determining device 322, such as a Global Positioning System (GPS) which provides for broadcasting signals to a plurality of location-determining satellites to determine the current location 324 of the mobile communication device 300. Once the current location 324 has been determined, the suggested payment type notification module 310 or some other routine/module/application executable on the mobile communication device 300 may identify the merchant 314 associated with the location. For example, the mobile communication device 300 may access a network-based mapping database (not shown in FIG. 4), which maps the geographic location to a merchant. In other embodiments of the invention the merchant 314 may be identified by other automated means. For example, the mobile communication device 300 may be configured to receive wireless communication from the merchant that is configured to identify the merchant 314.

Once the merchant 314 has been identified, the suggested payment type notification module 310 is further configured to identify the payment types 312 accepted by the merchant. In specific embodiments, the module 310 or some other module/application/routine accesses a network-based payment type database (not shown in FIG. 4) to determine the payment types 312 accepted by the identified merchant 314. The network-based payment type database is a comprehensive database that may be configured for dynamic update to reflect the current payment types accepted by merchants. Such dynamic update may be accomplished via crowd sourcing, actual user/consumer transaction data, known merchant information provided by merchants or the like.

In other specific embodiments the memory 306 of mobile communication device 300 includes payment type database 326 that stores information regarding the payment types 312 accepted by various merchants 314. The payment database 326 may be configured to automatically capture payment type information based on mobile payment transactions conducted by the user. In addition, the payment database 326 may be configured to receive user inputs that indicate the payment types 312 accepted by a merchant 314 (regardless of whether the user has conducted a mobile payment with the merchant). In further specific embodiments of the module, determination of the payment types accepted by a merchant may provide for accessing the payment database 326 to make a determination as whether the database 326 includes payment type 312 information for the merchant 314 of interest and, if the database 124 does not include information pertaining to the merchant 314 of interest, subsequently communicating with the network-based comprehensive payment type database to determine the payment types 312 accepted by the merchant 314 of interest.

In other embodiments of the invention, determination of the merchant 314 and/or the payment types 312 accepted by the merchant 314 may be accomplished through customer input. As such, the suggested payment type notification module 310 may be configured with a graphical user interface application (not shown in FIG. 4) that allows the customer to access for the purpose of inputting merchants and/or payment types accepted by the merchant so that the suggested payment type notification module 310 can subsequently suggest a payment type.

The suggested payment type notification module 310 is further configured to determine one or more suggested payment types 320 from amongst the payment types 312 determined to be accepted by the merchant 314, such that the customer will consider the suggested payment type 320 for a pending or considered transaction at the merchant 314. The suggested payment type 320 may, in certain embodiments be the most favorable payment type for the customer. Thus, the suggested payment type may be determined based on one or more payment type attributes which benefit the customer. As previously noted these attributes may include, but are not limited to, discounts 328, rebates/cash-back incentives 330, rewards program benefits 332, transaction fee waivers 334, transaction security features 336, extended warranty coverage 338 and the like. In specific embodiments the customer may preconfigure the attributes in terms of priority, such that the highest priority attribute is given the most weight in determining a suggested payment type(s) 320. In other embodiments, the module 310 may heuristically determine which payment type(s) is to be suggested based on considering all of the benefits afforded a payment type in comparison to benefits afforded other payment types.

It should also be noted that the payment type benefits associated with the attributes may be generic in nature (i.e., apply to all customers) or the benefits may be customer-specific benefits. In such embodiments in which the benefits are customer-specific, the module 310 may be in communication with a customer profile database, customer financial transaction database, customer financial account database or the like to identify the customer-specific benefit or the information in the database may be used as inputs to rules-based determination of the benefit associated with the customer.

In addition, the benefits associated with the attributes may be transaction-specific; taking into account the purchase amount and/or item type(s) included in the pending transaction. As such, suggested payment type notification application module 310 may direct the customer to capture computer readable-indicia (e.g., barcodes or the like) on items included in the pending transaction or otherwise direct the customer to make manual inputs to a graphical user interface (GUI) within the module to identify a proximate purchase amount and the items being considered for purchase. For example, purchase amount may dictate a higher savings amount in terms of a discount or rebate, while item type (e.g., electronic items) may favor extended warranty coverage.

In response to determining the suggested payment type(s) 320, the suggested payment type notification module 310 generates and initiates communication of a payment type notification/alert 340 to the customer, via user interface (not shown in FIG. 4) on the mobile communication device, that indicates one of more suggested payment types 320. In one specific embodiment the suggested payment types 320 may be limited to new/emerging payment types, such as mobile payment types and/or payment types not conventionally accepted by all merchants. While in other embodiments, the suggested payment types may not be limited to new/emerging payment types, such as mobile payment types or the like and/or payment types not conventionally accepted by all merchants, but rather may include any known or future known payment type accepted by the merchant, such as, but not limited to, debit/credit card payment type (issuing entity-specific and/or card provider specific), checking account, credit account, cash and the like.

The notification 340 may be communicated via any communication channel known or known in the future. Communication channels may include, but are not limited to, electronic mail (i.e., email), text, audible intelligent personal assistant or the like, which provide for the customer to receive the notification via the wireless communication device 310. In specific embodiments of the invention, the customer is able to preconfigure which communication channel they desire as their communication channel of choice.

In additional embodiments of the invention, in which at least one of the suggested payment types 320 in the notification 340 is a mobile payment type, the notification may include an option, via a selectable link or the like, for the customer choose the mobile payment type and, upon selection associated mobile payment mechanisms are automatically activated (e.g., image capture device, short range wireless communication broadcast device, related applications and the like).

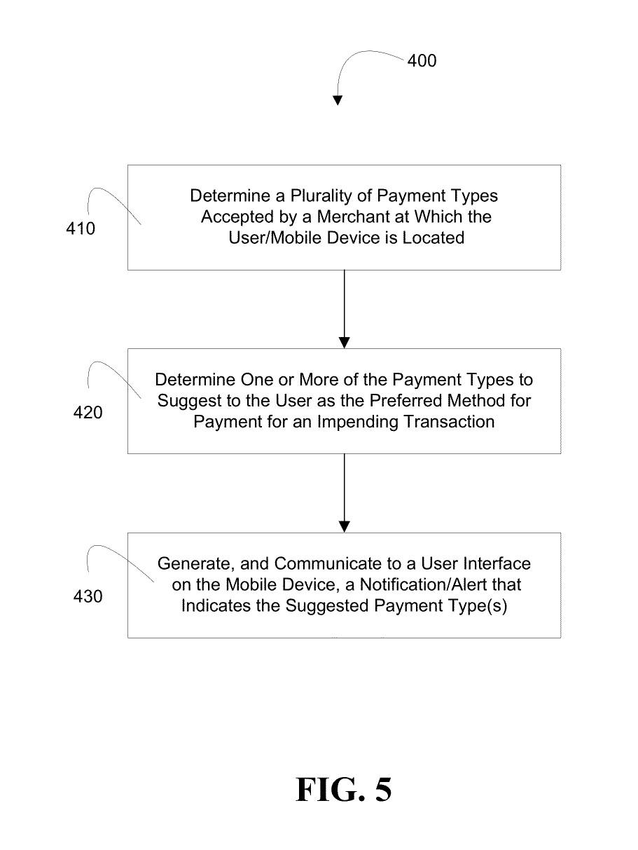

Referring to FIG. 5 a flow diagram is presented of a method 400 for notifying customers of suggested payment types accepted by a merchant prior to conducting a pending or considered transaction at the merchant, in accordance with embodiments of the present invention. At Event 410, the payment types accepted by the merchant are determined. In one embodiment such determination may include capturing computer readable-indicia (e.g., QR codes or the like) displayed at the merchant, such that the computer readable-indicia indicates the merchant and/or the payment types accepted by the merchant. In other embodiments the customer may access a user interface to provide a manual input that identifies the merchant and/or the payment types accepted by the merchant. In those embodiments in which the computer readable-indicia or the customer inputs only identify the merchant, the payment types may be identified by accessing an internal (i.e., mobile communication device) database and/or a network-based database that map merchants to payment types accepted.

In other related embodiments the payment types accepted by the merchant may be determined by a fully automated means, whereby location-determining mechanisms (GPS or the like) are used to automatically determine the location of the mobile communication device, the location maps to the merchant and payment types accepted by the merchant are identified by accessing an internal (i.e., mobile communication device) database and/or a network-based database that map merchants to payment types accepted.

At Event 420, a suggested payment type(s) for a pending or considered customer transaction at the merchant is determined from amongst the payment types accepted by the merchant. As previously noted, the suggested payment type may, in certain embodiments, be the most favorable payment type for the customer. Thus, the suggested payment type may be determined based on one or more payment type attributes which benefit the customer. As previously noted these attributes may include, but are not limited to, discounts, rebates/cash-back incentives, rewards program benefits, transaction fee waivers, transaction security features, extended warranty coverage and the like. In specific embodiments the attributes may be prioritized by the customer, such that the highest priority attribute is given the most weight in determining a suggested payment type. In other embodiments, the suggested payment type may be heuristically determined based on considering all of the benefits afforded a payment type in comparison to benefits afforded other payment types.

In specific embodiments the determination of the suggested payment type may be customer-specific and/or transaction specific. In customer-specific embodiments, determination of the suggested payment types may include accessing customer data, such as customer profile data, customer financial account data and/or customer transaction history data to identify or determine customer-specific benefits which are relevant to the determination of the customer-specific suggested payment type. In transaction specific embodiments, determination of the suggested payment types may include receiving, from customer input, computer readable-indicia capturing or the like, an approximate transaction amount or item information

At Event 430, a notification/alert including the suggested payment type is generated and communication of the same is initiated to a user interface on the mobile communication device. The communication channel (email, text, instant message or the like) used to communicate the notification may be preconfigured by the customer. Ion those embodiments in which the suggested payment type is a mobile payment type, the notification may include a link or some other suitable mechanism for the customer to choose the mobile payment type so as automatically activate mobile payment mechanisms (software, hardware, firmware or the like) associated with the selected mobile payment type.

Thus, as described in above, devices, methods and computer program are defined that provide for notifying (e.g., alerting) users of mobile devices as to suggested payment types accepted by the merchant at which the user is located. The suggested payment type may be one that is favorable or beneficial, in some embodiments most favorable, to the user in terms of discounts/rebates, transaction fee reduction, rewards points transaction processing security and/or extended warranty coverage for items transacted and/or the like. As a result the user makes informed decisions on which payment type to use for an impending transaction at the merchant.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A mobile communication device configured for providing a user with notification of a suggested mobile payment type for conducting a transaction while at a merchant location, the mobile communication device comprising:
a computing platform including a memory and at least one processor in communication with the memory; and
a suggested mobile payment type notification module, stored in the memory, executable by the processor and configured to:
determine one or more mobile payment types accepted by a merchant at which the mobile communication device is located;
in response to determination of the mobile payment types, determine one or more of the mobile payment types to suggest to the user as a payment type for a pending transaction; and
generate, and communicate to the user via the mobile communication device, a notification that indicates the one or more suggested mobile payment types.

2. The mobile communication device of claim 1, wherein the suggested mobile payment type notification module is further configured to determine a geographic location of the mobile communication device and identify the merchant based on the geographic location of the mobile communication device.

3. The mobile communication device of claim 2, wherein the suggested mobile payment type notification module is further configured to determine the one or more mobile payment types accepted by the merchant by accessing a mobile payment type database that indicates the one or more mobile payments types accepted by the merchant.

4. The mobile communication device of claim 1, wherein the suggested mobile payment type notification module is further configured to determine the one or more mobile payment types accepted by the merchant by capturing computer readable-indicia displayed at the merchant, wherein the computer readable-indicia indicates the one or more mobile payment types accepted by the merchant.

5. The mobile communication device of claim 1, wherein the suggested mobile payment type notification module is further configured to determine one or more of the mobile payment types to suggest to the user based on at least one of a discount associated with a mobile payment type, a rebate associated with a mobile payment type, rewards program benefits associated with a mobile payment type, warranty protection associated with a mobile payment type or security in processing a transaction associated with a mobile payment type.

6. The mobile communication device of claim 5, wherein the suggested mobile payment type notification module is further configured to determine the one or more of the mobile payment types to suggest to the user by accessing a database that maps the merchant to discounts or rebates associated with a mobile payment type.

7. The mobile communication device of claim 1, wherein the suggested mobile payment type notification module is further configured to determine one or more of the mobile payment types to suggest to the user based on at least one of an approximate transaction amount of a pending transaction with the merchant or one or more item types in the pending transaction with the merchant.

8. (canceled)

9. The mobile communication device of claim 1, further comprises a mobile payment activation module stored in the memory, executable by the processor and configured to automatically activate one or more mobile payment mechanisms associated with the mobile payment type, wherein the mobile payment mechanisms are automatically activated based on selection, by the user, of one of the suggested mobile payment types in the notification.

10. A method for notifying mobile communication device users of a suggested mobile payment type for conducting a transaction while at a merchant location, the method comprising:
determining, by a computing device processor, a one or more mobile payment types accepted by a merchant at which the mobile communication device is located;
determining, by a computing device processor, one or more of the mobile I payment types to suggest to the user as a payment type for a pending transaction; and
generating, and initiating communication to a user interface on the mobile communication device, a notification that indicates the one or more suggested mobile payment types.

11. The method of claim 10, further comprising determining a geographic location of the mobile communication device and identifying the merchant based on the geographic location of the mobile communication device.

12. The method of claim 11, wherein determining the one or more mobile payment types accepted by the merchant further comprises accessing a payment type database that indicates the one or more mobile payments types accepted by the merchant.

13. The method of claim 10, wherein determining the one or more mobile payment types accepted by the merchant further comprises capturing computer readable-indicia displayed at the merchant, wherein the computer readable-indicia indicates the one or more mobile payment types accepted by the merchant.

14. The method of claim 10, wherein determining the one or more mobile payment types to suggest to the user further comprises determining the one or more of the mobile payment types to suggest to the user based on at least one of a discount associated with a mobile payment type, a rebate associated with a mobile payment type, rewards program benefits associated with a mobile payment type, warranty protection associated with a mobile payment type or security in processing a transaction associated with a mobile payment type.

15. The method of claim 14, wherein determining the one or more mobile payment types to suggest to the user further comprises accessing a database that maps the merchant to discounts or rebates associated with a mobile payment type.

16. The method of claim 10, further comprising receiving, at the mobile communication device, an input that identifies at least one of an approximate transaction amount or item type for a pending user transaction with the merchant and wherein determining the one or more of the mobile payment types to suggest to the user further comprises determining the one or more mobile payment types to suggest to the user based on at least one of the approximate transaction amount or the item type.

17. (canceled)

18. The method of claim 10, further comprising automatically activating one or more mobile payment mechanisms associated with the mobile payment type, wherein the mobile payment mechanisms are automatically activated based on selection, by the user, of one of the suggested mobile payment types in the notification.

19. A computer program product comprising a non-transitory computer-readable medium comprising:
a first set of codes for causing a mobile communication device to determine a one or more mobile payment types accepted by a merchant at which the mobile communication device is located;
a second set of codes for causing a mobile communication device to determine one or more of the mobile payment types to suggest to the user as a payment type for a pending transaction; and
a third set of codes for causing a mobile communication device to generate, and communicate to a user interface on the mobile communication device, a notification that indicates the one or more suggested mobile payment types.

20. The computer program product of claim 19, further a fourth set of codes for causing the mobile communication device to determine a geographic location of the mobile communication device and identify the merchant based on the geographic location of the mobile communication device.

21. The computer program product of claim 20, wherein the first set of codes is further configured to cause the mobile communication device to access a payment type database that indicates the one or more mobile payments types accepted by the merchant.

22. The computer program product of claim 19, wherein the first set of codes is further configured to cause the mobile communication device to capture computer readable-indicia displayed at the merchant, wherein the computer readable-indicia indicates the one or more mobile payment types accepted by the merchant.

23. The computer program product of claim 19, wherein the second set of codes is further configured to determine the one or more of the mobile payment types to suggest to the user based on at least one of a discount associated with a mobile payment type, a rebate associated with a mobile payment type, rewards program benefits associated with a mobile payment type, warranty protection associated with a mobile payment type or security in processing a transaction associated with a mobile payment type.

24. The computer program product of claim 23, wherein the second set of codes is further configured to cause the mobile communication device to access a database that maps the merchant to discounts or rebates associated with a mobile payment type.

25. The computer program product of claim 19, further comprising a fourth set of codes for causing the mobile communication device to receive an input that identifies at least one of an approximate transaction amount or item type for a pending user transaction with the merchant and wherein the second set of codes is further configured to cause the mobile communication device to determine the one or more of the mobile payment types to suggest to the user based on at least one of the approximate transaction amount or the item type.

26. (canceled)

27. The computer program product of claim 19, further comprising a fourth set of codes for causing the mobile communication device to automatically activate one or more mobile payment mechanisms associated with the mobile payment type, wherein the mobile payment mechanisms are automatically activated based on selection, by the user, of one of the suggested mobile payment types in the notification.
